(19) United States
(12) Patent Application Publication
(10) Pub. No.: US 2011/0042600 A1
(43) Pub. Date: Feb. 24, 2011

(54) SPIGOT CONTROL SYSTEMS

(76) Inventors: David Malone, Glendale, AZ (US); David La-Falaise Brydl, Redondo Beach, CA (US)

Correspondence Address: RG Patent Consulting, LLC, 8275 E. Bell Rd., Apt. 2134, Scottsdale, AZ, 85260, US

(21) Appl. No.: 12/861,752

(22) Filed: Aug. 23, 2010

Related U.S. Application Data
(60) Provisional application No. 61/274,979, filed on Aug. 24, 2009.

(51) Int. Cl. F16K 31/60

(52) U.S. Cl. 251/293

(57) ABSTRACT

A spigot control system is disclosed herein comprising: an attacher assembly; and a torquer that attaches to an existing water dispensing system. The attacher assembly comprises male and female mated portions that interlock to a spigot handle. The attacher assembly substantially prevents rotation of the torquer in circumferential relation to the spigot by attaching around or to the spigot handle. The torquer provides a torque increasing means whereby a user may rotate and manipulate the spigot handle between open and closed conditions with relative ease. The torquer further comprises a securer providing securement means between the torquer and the spigot handle via the attacher assembly. The torquer may comprise durable material with appropriate strength, wear and fatigue characteristics suitable to withstand user-applied torque over a wide range of temperature variations within diverse environmental conditions. The spigot control system may also be attached to an existing beverage dispensing system. Various ornamental designs of the torquer and configurations of the attacher assembly are disclosed herein for the present invention.

### CROSS-REFERENCE TO RELATED APPLICATIONS

The present application is related to and claims priority from prior provisional application Ser. No. 61/274,979 and design application numbers 29/316,098 and 29/316,102 and 29/316,103 all filed Aug. 24, 2009 which applications are incorporated herein by reference.

### BACKGROUND OF THE INVENTION

1. Field of the Invention

The present invention relates generally to the field of spigots and more specifically relates to spigot control systems.

2. Description of the Related Art

Garden-type faucets or water spigots may be mounted on exteriors of commercial and/or residential properties. Normally spigots have handles which permit a user to manipulate the spigot from a closed position to an open position and back to a closed position. The spigot handles operate an interior valve connected to a valve shaft and are typically secured in place with a screw. Over time faucets or spigots may become difficult to operate as they incur multiple cyclic rotations which may include over-tightening, under-tightening, environmental degradation and other such events and conditions. These factors tend to cause the spigot components to undergo premature wear making them difficult to open and close.

Opening and closing of these water spigots may be difficult for the elderly, the young, or anyone with insufficient gripping strength. A solution to address this problem has been to increase the length of the moment arm of or attached to the handle thereby creating a torque multiplier means. However, due to size and shape variations, this may not provide a feasible or effective remedy. Further, by using this particular solution a user may easily over-tighten the handle leading into the spigot causing unnecessary damage to interior components. Damage to seals and gaskets often compromises confinement of water and/or liquid within the existing system typically leading to problems with leakage and pre-mature failure of the component.

Residential and/or commercial buildings may be left unattended during non-use periods, making the spigots vulnerable to unauthorized use and vandalism by persons who may activate the unattended spigot causing waste of natural resources and any resulting water induced damage caused by flooding. Modernly, most commercial and industrial spigots are designed to be fitted with a removable key called a ‘loose key’ or ‘water key’ typically comprising a square peg and a square ended key to turn off and on the water. This solution substantially prevents or limits unauthorized use, however water keys may be easily misplaced and with repeated uses may create wear on spigot components.

Another problem is that due to the close proximity and relative orientation of spigots to exterior surfaces of residential and commercial buildings, operation of such spigots may be difficult and access space limited. Manipulation of these spigots for rotating between open and closed conditions, attaching hoses and accessories may be troublesome leading to bruised or skinned knuckles, and/or pinched fingers. This situation may be amplified during adverse environmental conditions such as in extreme cold, or humid climatic conditions where handles may become frozen or slippery. Humid conditions may also accelerate degradation due to corrosion thereby making the water spigot increasingly difficult to operate.

Various solutions have been proposed for the aforementioned problems such as those found in U.S. Pat. Nos. 6,516,496, 7,398,954, 3,558,163, 4,575,130, 6,062,606, and 6,659,373. Although these patents address some of the problems stated previously, they often fail to provide a user-friendly design that will work on a variety of faucet types, and often do not take into account the proximity and limited space available. Further, the proposed solutions do not recognize the tendency to damage interior components of the spigots that may occur due to over-torquing of the handle(s).

Ideally, a spigot control system should operate reliably, be user friendly, and manufactured at a modest expense. Further, the spigot control system should be aesthetically pleasing, be easy to operate within a confined space and allow for accurate control during the opening and closing processes. Thus, a need exists for a reliable spigot control system to avoid the above-mentioned problems.

### BRIEF SUMMARY OF THE INVENTION

A spigot control system is disclosed herein comprising: an attacher assembly; and a torquer that attaches to an existing water dispensing system. The attacher assembly comprises male and female mated portions that interlock to a spigot handle. The attacher assembly allows rotation of the spigot handle, yet substantially prevents rotation of the torquer in relation to the spigot by attaching around or to the spigot handle. The torquer provides a torque increasing means whereby a user may rotate and manipulate the spigot handle between open and closed conditions with relative ease. The torquer further comprising a securer providing securement means between the torquer and the spigot handle via the attacher assembly. The torquer may comprise durable material with appropriate strength, wear and fatigue characteristics suitable to withstand user-applied torque over a wide range of temperature variations within diverse environmental conditions. Various ornamental designs of the torquer and configurations of the attacher assembly are disclosed herein for the present invention.

A kit is embodied herein for the spigot control system comprising: at least one attacher assembly; at least one torquer; and a set of user instructions. The kit may comprise various embodiments of the present invention and be marketed accordingly. Components from the kit of the spigot control system may be inter-changeable with other kits of the spigot control system for use with existing water systems.

In accordance with the embodiments of the present invention a preferred method of use is disclosed herein comprising: installing an attacher assembly to a spigot handle; installing a torquer over or to the spigot handle to secure the torquer and the spigot handle in a removably couplable relationship to one another via the attacher assembly; manipulating the spigot handle via the torquer to operate the spigot between open and/or closed positions thereby permitting or restricting at least one flow of water.

The present invention holds significant improvements and serves as a spigot control system. These and other features, aspects, and advantages of the present invention will become better understood with reference to the following drawings and description.

### BRIEF DESCRIPTION OF THE DRAWINGS

FIG. 1 shows a perspective view illustrating a spigot control system according to an embodiment of the present invention.

FIG. 2 is a perspective frontal view illustrating an embodiment of the spigot control system according to an embodiment of the present invention of FIG. 1.

FIG. 3 is an exploded view illustrating an embodiment of the present invention of FIGS. 1 and 2.

FIG. 4 is a perspective view illustrating various embodiments of torquer(s) of the spigot control system according to an embodiment of the present invention of FIG. 1.

FIG. 5 is a perspective view illustrating various embodiments of attacher(s) of the spigot control system according to an embodiment of the present invention of FIG. 1.

FIG. 6 is a perspective view illustrating an alternate embodiment of the spigot control system according to another embodiment of the present invention.

FIG. 7 is a flowchart illustrating methods of use according to embodiments of the present invention of FIGS. 1 and 6.

The various embodiments of the present invention will hereinafter be described in conjunction with the appended drawings, wherein like designations denote like elements.

### DETAILED DESCRIPTION

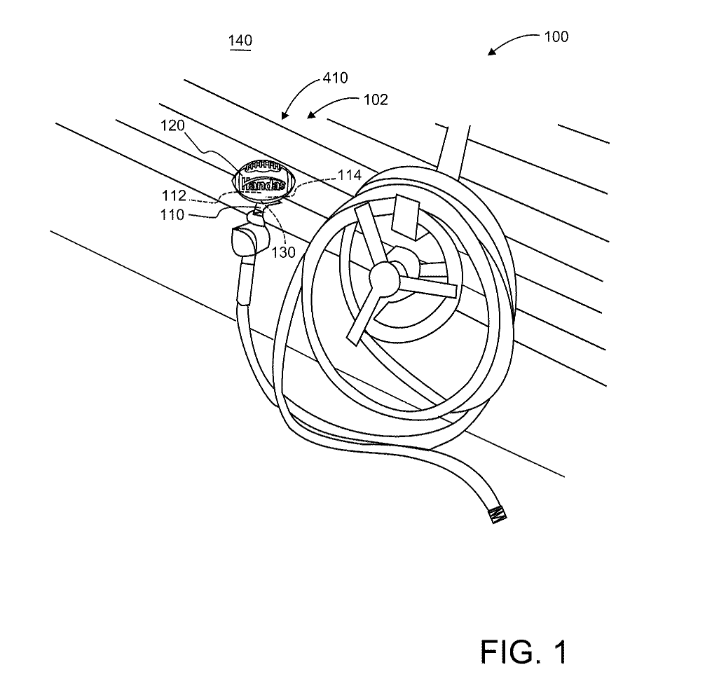

Referring now to FIGS. 1-3, showing perspective and exploded views illustrating spigot control system 100 according to embodiments of the present invention.

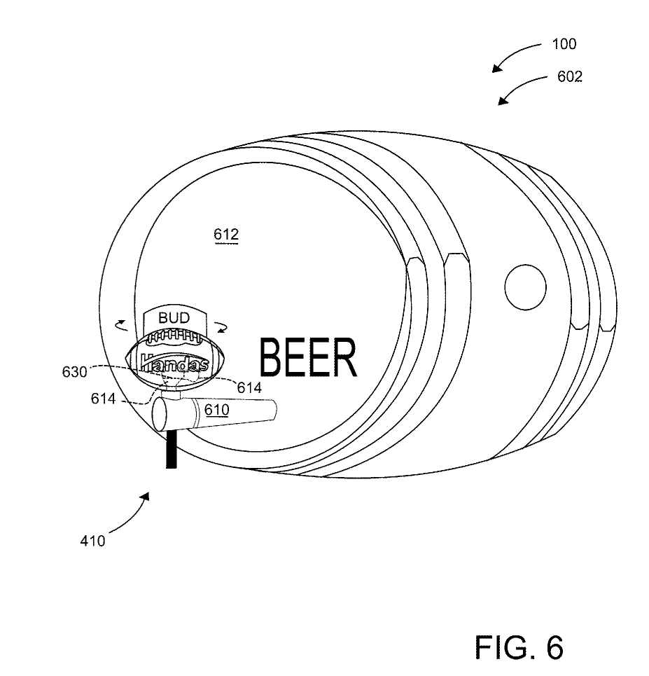

Garden-type faucets or water spigots 110 as mentioned previously may be mounted on exterior building wall(s) 140 of commercial and/or residential properties. Faucets may also be mounted in interiors of commercial and/or residential properties and in remote locations such as on hydrants, on golf courses, in gardens and other various locations. Faucets may also be used for different applications such as dispensing fluids other than water. Such applications may include dispensing of liquids from existing beverage dispensing systems 602 such as alcohol from beer kegs 612 as shown and discussed in FIG. 6. It should be appreciated that the present invention may be used for a variety of applications and those described herein are intended to provide an exemplary means to make and use the invention and are not to be construed in any way to limit its usage to equivalent applications.

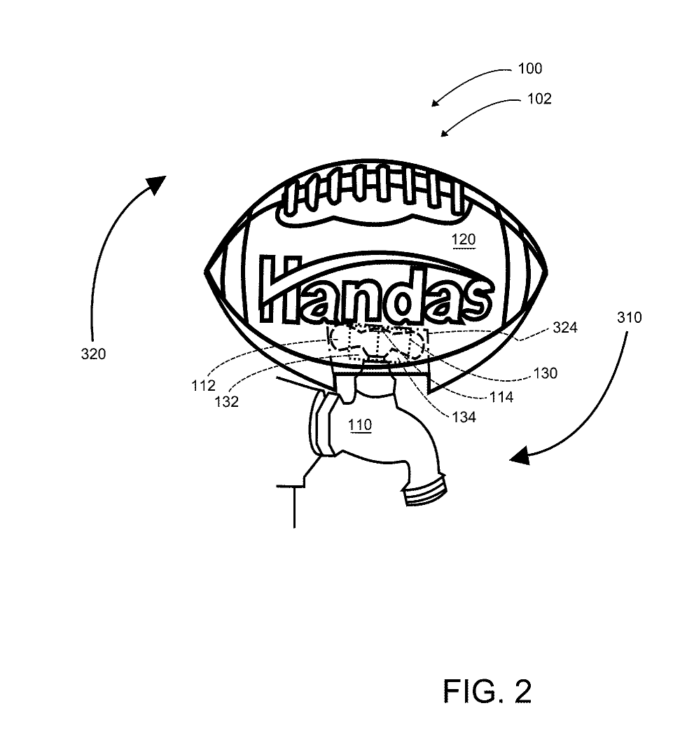

Normally water spigots 110 have handles 112, as shown in FIGS. 2, 3 and 6, which preferably permit a user to manipulate water spigot 110 from closed position 310 to open position 320 and back to closed position 310. Handle 112 of water spigot 110 is typically rotated through torquing by at least one user from closed position 310 to open position 320 and back to closed position 310. Handles 112 operate an interior valve connected to a valve shaft and may be secured in place with a screw or coupling nut 114.

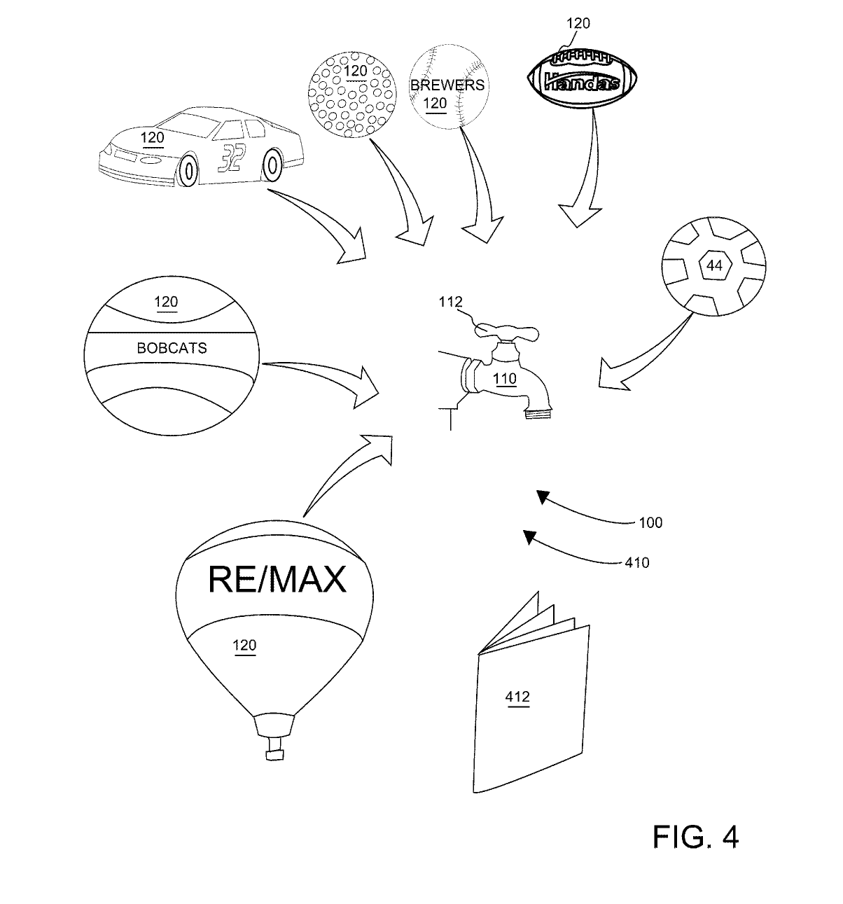

Handles 112 of water spigot 110 may comprise different shapes and designs such as oval, circular, T-shaped bar, L-shaped bar and others. Handles 112 of water spigots 110 may also comprise different sizes and different orientations to building wall 140. The present invention serves to provide an effective and efficient means whereby such handles 112 may be operated with relative ease to rotate handles 112 in relation to water spigot 110 in a clockwise and counter-clockwise direction to open and/or close an inner valve. It should be appreciated that there are various stages of closed position 310 and open position 320 and that spigot control system 100 may be used to effectively manipulate the valve of water spigot 110 to control the amount of water flow ranging from completely restricted to fully free-flowing depending on user-preference. Various embodiments of spigot control system 100 take into account the various sizes and shapes of handles 112 as will be shown and described in more detail in FIGS. 4, 5 and 6.

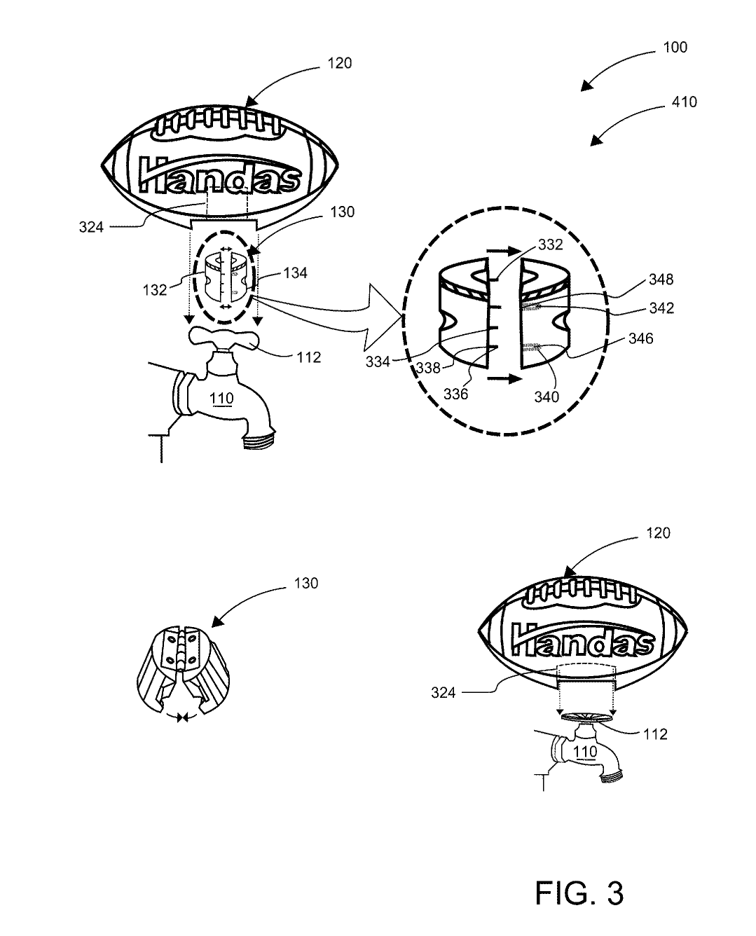

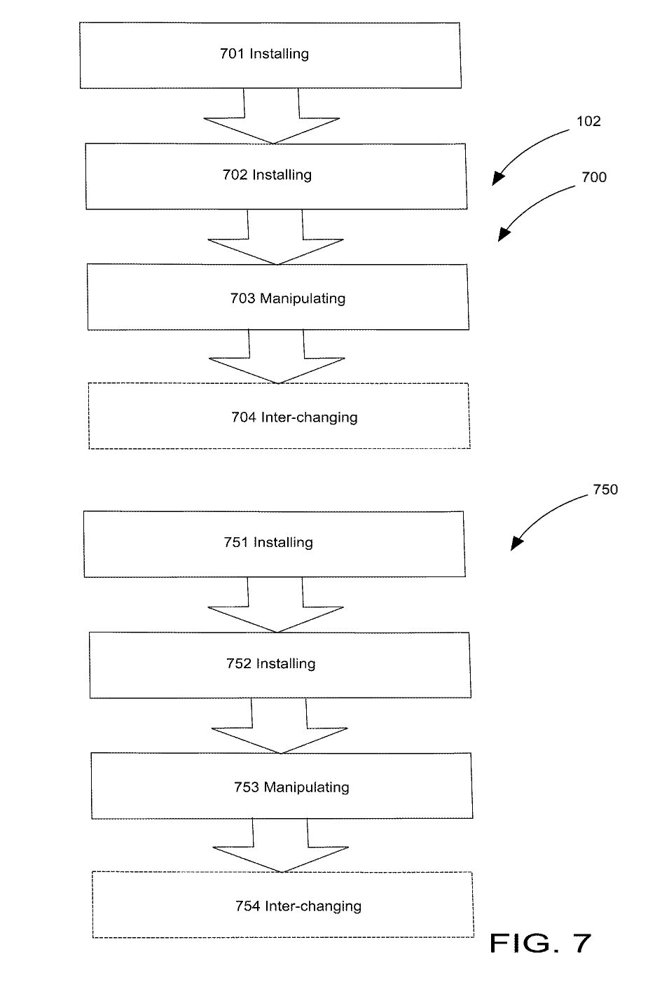

Spigot control system 100 may comprise: at least one attacher assembly 130; and torquer 120 that may removably couple to existing water dispensing system 102, as shown in the present figure and in FIGS. 2 and 3. Spigot control system 100 may be retro-fit to existing water dispensing system 102, as shown in FIGS. 1-3, and 5 or to existing beverage dispensing systems 602, as shown in FIG. 6. Methods of use 700 and 750 are also discussed in FIG. 7 for existing water dispensing system 102 and existing beverage dispensing systems 602, respectively.

Attacher assembly 130 comprises male and female mated portions 132 and 134, respectively, that effectively interlock to handle 112, as also shown and discussed in FIGS. 2, 3, and 6. Attacher assembly 130 allows rotation of handle 112, yet substantially prevents rotation of torquer 120 circumferentially in relation to body of water spigot 110 by attaching firmly around or to handle 112. Attacher assembly 130 allows rotation of handle 112 to provide sufficient rotating means within the confined space due to the close proximity of water spigot 110 attached to existing water dispensing system 102 to building wall 140. Male portion 132 and female mated portion 134 of attacher assembly 130 may be removably coupled together substantially enclosing handle 112. The mentioned removably coupled relationship between male mated portion 132 and female mated portion 134 is shown in an exploded view in FIG. 3 wherein male mated portion 132 comprises at least one protrusion 332, more specifically within the present embodiment comprises four protrusions 332. Protrusions 332 serve as mated members to apertures 340 that are found in female mated portion 134. In this way the present invention provides a securement means between male mated portion 132 and female portion 134 in a removably couplable relationship.

Protrusions 332 further comprise exterior volume 334 and proximal and distal ends 336 and 338, respectively. Aperture 340 comprises inner volume 342 and proximal and distal ends 346 and 348, respectively. Exterior volume 334 of protrusion 332 is designed to friction fit substantially within inner volume 342 of aperture 340 to create a close proximate relationship between handle 112 and attacher assembly 130 and to effectively prevent and/or reduce slack between the two components. As handle 112 is rotated in relation to water spigot 110, exterior volume 334 of protrusion 332 is in a contact friction-relationship with inner volume 342 of aperture 340 thereby creating a pseudo-locking relationship. In this way attacher assembly 130 may be held together. Attacher assembly 130 may also be held together in other ways in alternate embodiments such as by having one side spring-loaded, by having clips or hooks, by magnets or other suitable attaching and releasing means.

Within this particular embodiment, attacher assembly 130, comprises male mated portion 132 and female mated portion 134 which may comprise plastic, ferrous, non-ferrous, composite or other suitable material conducive to durability within various environmental conditions. The embodiment shown comprises polymer plastic of high molecular weight, and may contain other substances to improve performance and/or reduce costs to provide a cost-effective spigot control system 100 that may be manufactured at a reasonable price. Spigot control system 100 may be cast, pressed or extruded during the manufacturing process from thermoplastic or thermoset plastic. Use of plastic within spigot control system 100 provides resistance to corrosion from moisture. Plastics that may be used within attacher assembly 130 of the present invention include but are not limited to polypropelene, acrylonitrile butadiene styrene, polyethylene terephthalate, and polyvinyl chloride. The specific type of plastic may be selected based upon its characteristics such as resistance to ultra-violet sunlight or other to provide a durable product for extended longevity. In this way the present invention requires minimal maintenance, and is cost-effective to manufacture and use.

Attacher assembly 130 may comprise color-coding identification means whereby the top and bottom are identified visually to make it easier for a user to assemble and install on handle 112. This is accomplished by color-indicating means whereby mating portions of male mated portion 132 and female mated portion 134 are designated, as shown. For example blue end of male mated portion 132 is matched with blue end of female mated portion 134, leaving the matching white ends of male and female mated portions 132 and 134 respectively. Other indication means may also be used such as texturing, markings, different sized protrusions 332 that only fit in the applicable aperture 340 and other differentiating means. In this way the present invention serves to promote efficiency in assembly.

Within other embodiments, attacher assembly 130 may comprise a spring-loaded clamper and bottom button release that may be perpendicular or parallel to handle 112. In other embodiments attacher assembly 130 may comprise a hinging means and/or magnetic means for securement. It should be appreciated that many other equivalent derivations may be envisioned; however the examples provided serve as an exemplary means whereby a user may be enabled in reproducing and using the present invention in its intended purpose. It should also be appreciated that the present invention may be used in many related user-applications and that those named herein are not intended to be limited as such.

In another embodiment of the present invention, attacher assembly 130 comprises a snap-fit version whereby attacher assembly 130 and handle 112 comprise a snap-fit relationship. This particular embodiment may comprise a friction-fit or friction-increasing means to secure the components of spigot control system 100 to water spigot 110. Attacher assembly 130 within this particular embodiment may comprise rubber or other such suitable elastomeric material wherein strain energy is stored thermally.

Torquer 120 provides a torque multiplying means whereby a user may rotate and manipulate handle 112 between open positions 320 and closed positions 310 with relative ease. It should also be noted that torquer 120 provides a controlled torque multiplying means whereby the material of torquer 120 provides a ‘feel’ for user that substantially prevents over-tightening. These features are especially convenient for those not having the strength to rotate handle 112. Torquer 120 further comprises securer 324 providing securement means between torquer 120 and handle 112 via attacher assembly 130. Torquer 120 may comprise durable material with appropriate strength, wear and fatigue characteristics suitable to withstand user-applied torque over a wide range of temperature variations within diverse environmental conditions.

Torquer 120 may comprise plastics, ferrous or non-ferrous materials, composites and/or foams that provides user-comfort when manipulating. Preferably, torquer 120 is ergonomic allowing the user to maintain a steady, positive grip on a larger surface of torquer 120 as compared to the surface area of handle 112. Further, the larger grippable surface area of torquer 120 creates a more evenly distributed load. Torquer 120 may comprise various shapes and sizes some of which are shown in FIG. 4. Torquer 120 may be of a limited profile height so as to meet the confined space restrictions between water spigot 110 and building wall 140. Torquer 120 may be at an angle parallel with building wall 140 or on a relative angle less 90 degrees to building wall 140. In either orientation, torquer 120 should not come into contact with building wall 140. Despite the confined space restrictions between water spigot 110 and building wall 140, torquer 120 may be sufficiently rotated so as to activate existing water dispensing system 102. In this manner the present invention substantially prevents injuries to the user's fingers or knuckles. Another benefit of spigot control system 100 is that the materials used in torquer 120 and attacher assembly 130 are effectively non-conductive thereby reducing chances of electrical shock and minimizing thermal conductance.

The exploded view of FIG. 3 illustrates how spigot control system 100 may be installed on water spigot 110 of existing water dispensing system 102. Also shown is the relationship of male mated portion 132 and female mated portion 134 of attacher assembly 130.

Referring now to FIG. 4 in conjunction with the present figures, torquer 120 may comprises various shapes and sizes creating a torque increasing means. These shapes and sizes of torquer 120 may be used to effectively create a longer lever arm thereby minimizing input of the required force to rotate handle 112 in a substantially perpendicular orientation about the vertical axis of water spigot 110. Typically the vertical axis of water spigot 110 is substantially parallel to building wall 140. This creates a mechanical advantage by increasing the moment arm thereby reducing the magnitude of the torque required to rotate handle 112 between positions. Torquing means may be increased by a larger force moment in relation to the smaller force moment of handle 112. This action may be used to overcome rotational resistance by create a coupling rotation without translation, about the center of mass of water spigot 110. Within the present embodiment increased precision and torqueability control are realized due to the increased length of the moment arm and increased available grippable surface area.

Torquer 120 comprises at least one securer 324 that comprises an inner volume integral with torquer 120. Securer 324 may be located integral to and substantially within the lower portion of torquer 120, as shown. Securer 324 may comprise a formed shape to match handle 112 to provide at least one locking means whereby securer 324 of torquer 120 is placed in a removably couplable relationship over attacher assembly 130 and handle 112. In this way the entire assembly of spigot control system 100 is securely attached to handle 112 of water spigot 110 of existing water dispensing system 102. For example, securer 324 may comprise a oval insert to mate with an oval handle 112. Torquer 120 comprises securer 324 to substantially house attacher assembly 130 and appropriate shaped handle 112.

Referring again now to FIG. 4, showing a perspective view illustrating various embodiments of torquer(s) 120 of spigot control system 100 according to embodiments of the present invention of FIG. 1. Torquer 120 may comprise basketballs, baseballs, Nascar®, holiday themes, or a plastic disk-cap. Upon reading this specification, it should be appreciated that, under appropriate circumstances, considering such issues as user preferences, design preference, structural requirements, marketing preferences, cost, available materials, technological advances, etc., other torquer designs and themes such as, for example, other sports including team mascots, hockey, swimming, gymnastics, track and field, tennis, weight lifting, cycling, cue sports, archery, fishing, flying disk sports, motorcycling, polo, surfing, skateboarding, racquetball, squash, golf, and other themes, insignias, indicia, special events such as holidays, animal caricatures, etc., may be sufficient.

As mentioned previously, torquer 120 may comprise various shapes related to sports equipment. For example, a user may choose torquer 120 that comprises a football or a helmet with indicia of his or her favorite team. If a user chooses a football, he or she may have their favorite college or professional team's inscribed on the outer surface of torque 120.

Another example may include having torquer 120 shaped like a balloon and having the Re/Max® logo. In this way the present invention may provide advertising means. In other embodiments torquer 120 may comprise Santa Claus, a pumpkin, the Easter Bunny, or a sombrero to signify a holiday-based theme. In instances where spigot control system 100 is used in a garden, the shape may take the form of a flower, dragonfly, or a ladybug. It should be understood that variations of the present invention can take many forms and still remain within the scope and spirit of the novelty addressed herein.

In embodiments with a Nascar® theme, torquer 120 may comprise the semblance of a vehicle such as race car, as shown, a race truck, race bike, or a race boat. Such semblance may further comprise sponsor advertisement, driver number, and other suitable coloring and/or indicia.

In another embodiment, torquer 120 may comprise indicia advertising the trademark name of spigot control system 100 such as Garden Fan™. Other embodiments are shown and may include indicia such as ASU Alumni, sponsors or company logos.

Within FIGS. 3, and 4 kit 410 is embodied herein for spigot control system 100 for use with existing water dispensing system 102 comprising: at least one attacher assembly 130; at least one torquer 120; and set of user instructions 412. The kit may comprise various embodiments of the present invention and be marketed accordingly. Components from kit 410 of spigot control system 100 may be inter-changeable with other kits 410 of spigot control system 100 for use with existing water systems 102. FIG. 6 alludes to kit 410 that is available for use with existing beverage dispensing system 602.

Kit 410 may be manufactured and provided for sale in a wide variety of sizes and shapes for a wide assortment of applications. The various components may be interchangeable between kits 410. For example, a user may seasonally replace torquer 120 that is shaped like a baseball with torquer 120 that shaped like a basketball when the baseball season is completed. Further, torquer 120 of kit 410 may be user-selected based on user's favorite team and further specify favorite player and team number and/or color. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

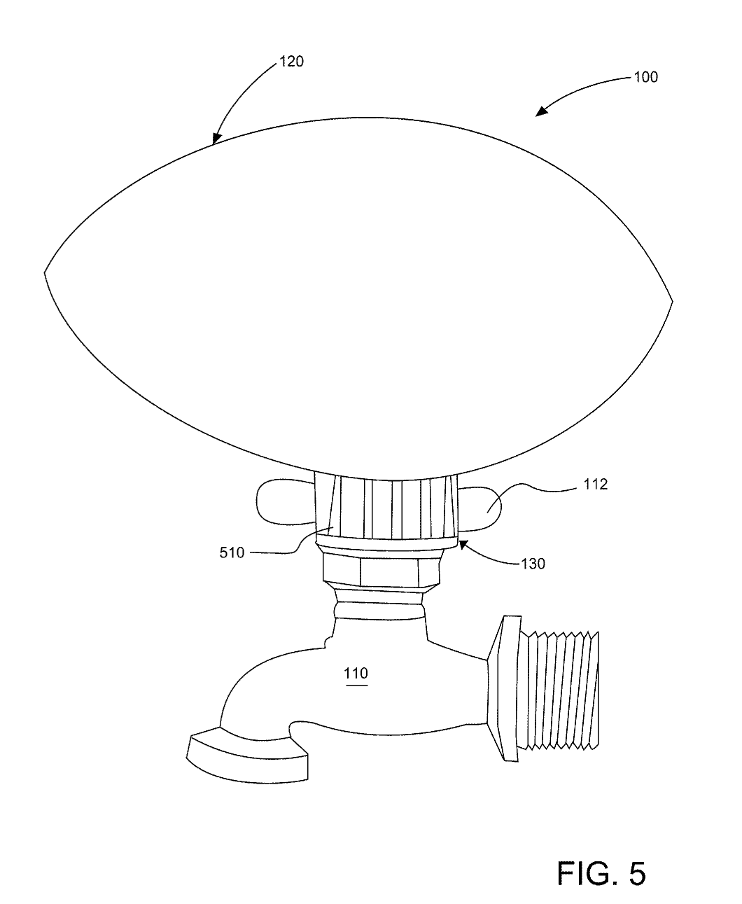

Referring now to FIG. 5, showing a perspective view illustrating various embodiments of attacher(s) of spigot control system 100 according to an embodiment of the present invention of FIG. 1. FIG. 5 illustrates graduated splines 510 of attacher assembly 130 whereby torquer 120 is allowed to progressively come into an increased frictional relationship with attacher assembly 130 as torquer 120 is pushed downwardly towards handle 112. Splines 510 are substantially vertical within this particular embodiment and effectively increase in width proximate lower portion of attacher assembly 130 nearest water spigot 110, as shown. As distance increases from water spigot 110 splines 510 decrease in width, thereby allowing a user-preferred tightness to be administered with spigot control system 100.

Referring now to FIG. 6, showing a perspective view illustrating an alternate embodiment of spigot control system 100 according to the present invention. Within this particular embodiment torquer 120 may be also used in combination with existing beverage dispensing system 602 such as beer tap 610 on keg 612 by creating at removably couplable relationship between beer tap handle 614 and torquer 120 via attacher assembly 630. Attacher assembly 630, similar to attacher assembly 130 may also provide alternate attaching means whereby taps with L-shaped, T-shaped, U-shaped and other shape configurations may be suitably secured. Securer 324 is preferably altered to fit the appropriate configurations, thereby allowing torquer 120 to fit in at least one frictional relationship and provide positive turning/rotating means.

Existing beverage dispensing system 602 may be for use in dispensing liquids including alcoholic and non-alcoholic beverages as well as for other comestible liquids and non-liquids. Comestible liquids may include coffee, juices, sodas, milks and other drinks and non-liquids may include ice creams, yoghurts and others. In this manner the present invention may be used to purvey foods from a wide range of temperatures and provide an insulation and/or isolation means to protect a user's hand from thermal fluctuations. Further, the present invention may be used with non-comestible liquids and non-liquids.

Beer tap 610 in the present figure comprises a valve with a tap, for controlling the egress of beer. Beer tap 610 is activated to dispense beer when torquer 120 is rotated, thereby opening valve and allowing at least one flow of beer. Beer from keg 612 may be served with the aid of external or internal pressure. In this way the present invention may be used to purvey alcoholic and other various liquids when a user rotates torquer 120 to open beer tap 610. Further, the present invention provides a means whereby pressurized liquids of various densities of less than 1000 kg/m³ equal to and greater than 1000 kg/m³ may be purveyed.

The pressure behind beer tap 610 may be supplied by a canister of carbon dioxide (CO₂) connected to each of kegs 612. Torquer 120 may be used in conjunction with other means of alcohol purveying taps used with or without pressure. Torquers 120 may be adjacent and in close proximity to other torquers 120 when used with existing beverage dispensing system 602, (such as at a bar) or for use with existing water dispensing system 102. Upon reading this specification, it should be appreciated that, under appropriate circumstances, considering such issues as user preferences, design preference, structural requirements, marketing preferences, cost, available materials, technological advances, etc., other liquid dispenser or containment means and arrangements such as, for example, beer tower taps, portable kegs etc., may be sufficient.

Torquer 120 may be decorative and/or may include indicia or advertisements for example of a favorite beer, college or professional sports team. When torquer 120 is rotated to open beer tap 610, beer may be pushed by the pressurized gas from the cylinder, to flow into a container such as a mug. Beer tap 610 may be used to prevent or aid the flow of the liquid and/or pressurized gas. Beer tap 610, in conjunction with torquer 120, may act as an on-off or open-close switch to control the amount of beer that is released from keg 612.

Referring now to FIG. 7, showing a flowchart illustrating methods of use 700 and 750 according to embodiments of the present invention of FIGS. 1 and 6.

In accordance with the embodiments of the present invention a preferred method of use 700 with existing water dispensing system 102 is disclosed herein comprising: step one 701 installing attacher assembly 130 to spigot handle 112; step two 702 installing torquer 120 over or to spigot handle 112 to secure torquer 120 and spigot handle 112 in a removably couplable relationship to one another via attacher assembly 130; step three 703 manipulating spigot handle 112 via torquer 120 to operate water spigot 110 between open position 320 and/or closed positions 310 and thereby permitting or restricting at least one flow of water from existing water dispensing system 102. Step four 704 may optionally include inter-changing torquer 120 with another compatible torquer 120 with a different theme and/or indicia.

It should be noted that step 704 and 754 are considered optional steps and may not be implemented in all cases. Optional steps of methods 700 and 750 are illustrated using dotted lines in FIG. 7 so as to distinguish them from the other steps of method 700 and 750.

In accordance with the embodiments of the present invention a preferred method of use 750 with existing beverage dispensing system 602 is disclosed, wherein step one 751 comprises installing attacher assembly 630 to beer tap 610 or other suitable beverage dispenser; step two 752 installing torquer 120 over or to beer tap 610 to secure torquer 120 and beer tap 610 in a removably couplable relationship to one another via attacher assembly 630; step three 753 manipulating beer tap 610 via torquer 120 to operate beer tap 610 between open position 320 and/or closed positions 310 and thereby permitting or restricting at least one flow of an alcoholic or non-alcoholic beverage from existing beverage dispensing system 602. Step four 754 may optionally include inter-changing torquer 120 with another compatible torquer 120 with a different theme and/or indicia such as from for example Miller® to Guinness®.

It should be noted that the steps described in methods of use 700 and 750 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention.

What is claimed is new and desired to be protected by Letters Patent is set forth in the appended claims:

1) A spigot control system comprising:
an attacher assembly; and
a torquer that attaches to a spigot handle of an existing water dispensing system to provide a torque increasing means whereby a user may rotate and manipulate said spigot handle between open and closed conditions.

2) The spigot control system of claim 1 wherein said attacher assembly comprises male and female mated portions.

3) The spigot control system of claim 1 wherein said torquer further comprises a securer providing securement means between said torquer and said spigot handle via said attacher assembly.

4) The spigot control system of claim 3 wherein said securer comprises at least one graduated spline whereby said torquer is allowed to progressively come into an increased frictional relationship with said attacher assembly as said torquer is pushed downwardly towards said spigot handle.

5) The spigot control system of claim 1 wherein said torquer is manufactured to frictionally fit onto said spigot control handle comprising an oval shape.

6) The spigot control system of claim 1 wherein said torquer is manufactured to frictionally fit onto said spigot control handle comprising a circular shape.

7) The spigot control system of claim 1 wherein said torquer is manufactured to frictionally fit onto said spigot control handle comprising a T-shaped bar.

8) The spigot control system of claim 1 wherein said torquer is manufactured to frictionally fit onto said spigot control handle comprising an L-shaped bar.

9) The spigot control system of claim 2 wherein said attacher assembly that interlock to said spigot handle.

10) The spigot control system of claim 9 wherein said male portion of said attacher assembly comprises at least one protrusion with an exterior volume.

11) The spigot control system of claim 9 wherein said female portion of said attacher assembly comprises at least one aperture with an inner volume.

12) The spigot control system of claim 1 wherein said attacher assembly wherein said male and female mated portions are held together using a hinged means.

13) The spigot control system of claim 1 wherein said torquer comprises indicia.

14) The spigot control system of claim 3 further comprising a kit wherein the kit comprises: at least one attacher assembly; at least one torquer; and a set of user instructions, wherein said at least one attacher assembly and said at least one torquer may be inter-changeable with other of said kits.

15) The spigot control system of claim 3 wherein said torquer, said securer and said attacher comprise non-ferrous material.

16) A method of using a spigot control system comprising the steps of:
installing an attacher assembly to a spigot handle;
installing a torquer to said spigot handle to secure said torquer and said spigot handle in a removably couplable relationship to one another via said attacher assembly; and
manipulating said spigot handle via said torquer to operate water spigot between an open position and/or a closed positions thereby permitting or restricting at least one flow of water from an existing water dispensing system.

17) The method of using a spigot control system of claim 16 further comprising the step of inter-changing said torquer with another of said torquer with a different theme.

18) The method of using a spigot control system of claim 17 wherein said torquer comprises at least one different indicia.

19) A method of using a spigot control system with an existing beverage dispensing system comprising the steps of:
installing an attacher assembly to a beer tap or other suitable beverage dispenser;
installing a torquer to said beer tap to secure said torquer and said beer tap in a removably couplable relationship to one another via said attacher assembly;
manipulating said beer tap via said torquer to operate said beer tap between an open position and/or a closed positions thereby permitting or restricting at least one flow of an alcoholic or non-alcoholic beverage from said existing beverage dispensing system.

20) The method of using the spigot control system with an existing beverage dispensing system of claim 19 further comprising the step of inter-changing said torquer with another compatible torquer with a different theme and/or indicia.
